(19) United States
(12) Patent Application Publication
(10) Pub. No.: US 2020/0160500 A1
(43) Pub. Date: May 21, 2020

(54) PREDICTION DEVICE, PREDICTION METHOD, AND STORAGE MEDIUM

(71) Applicant: HONDA MOTOR CO., LTD., Tokyo (JP)

(72) Inventors: Atsuyuki Suzuki, Wako-shi (JP); Masanori Takeda, Wako-shi (JP); Yasuaki Aoki, Tokyo (JP); Hirokazu Watanabe, Wako-shi (JP)

(21) Appl. No.: 16/680,542

(22) Filed: Nov. 12, 2019

(30) Foreign Application Priority Data
Nov. 16, 2018 (JP) 2018-215602

(51) Int. Cl. G06T 7/00; G06K 9/00; G06K 9/62

(52) U.S. Cl. CPC G06T 7/0002; G06K 9/00771; G06K 9/6288; G06T 2207/30252; G06K 9/6256; G06T 2207/20081; G06T 2207/30232; G06K 9/00791

(57) ABSTRACT

A prediction device includes: an acquirer configured to acquire a captured image of a scene of a section in a town and released information representing a value for the section; and a deriver configured to derive a public safety index representing a public safety state of the section in the future by inputting a result of analyzing the image and the released information to a prediction model.

### CROSS-REFERENCE TO RELATED APPLICATION

Priority is claimed on Japanese Patent Application No. 2018-215602, filed Nov. 16, 2018, the content of which is incorporated herein by reference.

### BACKGROUND

### Field of the Invention

The present invention relates to a prediction device, a prediction method, and a storage medium.

### Description of Related Art

In the related art, an invention of a security guard system including a detector configured to detect an abnormality in a security guard region and transmit an abnormal detection signal to a controller in a case in which an abnormality is detected and the controller configured to receive public safety information in a target area including the security guard region and change determination conditions for determining whether or not to issue an alert in accordance with the public safety information has been disclosed (Japanese Unexamined Patent Application, First Publication No. 2014-178884). According to the invention, the public safety information is generated mainly on the basis of crime information. For example, there is a description that the numbers of break-in robbery cases and break-in theft cases that have occurred in a target area in a predetermined period are used as source information of the public safety information.

### SUMMARY

However, it is not possible to appropriately estimate a public safety state in the future in some cases according to the related art.

Aspects of the invention were made in view of such circumstances, and one of objectives is to provide a prediction device, a prediction method, and a storage medium capable of appropriately estimating a public safety state in the future.

The prediction device, the prediction method, and the storage medium according to the invention employ the following configurations:

(1): According to an aspect of the invention, there is provided a prediction device including: an acquirer configured to acquire a captured image of a scene of a section in a town and released information representing a value for the section; and a deriver configured to derive a public safety index representing a public safety state of the section in the future by inputting a result of analyzing the image and the released information to a prediction model.

(2): In the aforementioned aspect (1), the deriver derives the public safety index for a section with a rate of change in the released information that is equal to or greater than a reference value.

(3): In the aforementioned aspect (1), the deriver derives the public safety index by evaluating a state of a specific object included in the image.

(4): In the aforementioned aspect (1), the released information includes at least a part of information related to roadside land assessments, rents, and crime occurrence.

(5): In the aforementioned aspect (1), the section is a specific section along a road.

(6): In the aforementioned aspect (1), the prediction device further includes: a learner that generates the model through machine learning.

(7): In the aforementioned aspect (1), the released information is used as teacher data when the model for deriving the public safety index is learned.

(8): According to another aspect of the invention, there is provided a prediction method that is performed using a computer, the method including: acquiring a captured image of a scene of a section in a town and released information representing a value for the section; and deriving a public safety index representing a public safety state of the section in the future by inputting a result of analyzing the image and the released information to a prediction model.

(9): According to yet another aspect of the invention, there is provided a storage medium that causes a computer to: acquire a captured image of a scene of a section in a town and released information representing a value for the section; and derive a public safety index representing a public safety state of the section in the future by inputting a result of analyzing the image and the released information to a prediction model.

According to the aforementioned aspects (1) to (9), it is possible to appropriately estimate a public safety state in the future.

According to the aforementioned aspect (2), it is possible to improve processing efficiency.

According to the aforementioned aspect (3), it is possible to estimate a public safety state in the future with higher accuracy since image processing is not performed in a vague manner but is performed by narrowing down to a specific object.

According to the aforementioned aspect (4), it is possible to estimate a public safety state in the future from diversified viewpoints.

According to the aforementioned aspect (5), it is possible to perform estimation processing with higher granularity as compared with estimation in mesh units in a map in the related art.

### BRIEF DESCRIPTION OF THE DRAWINGS

FIG. 1 is a diagram illustrating an example of configurations that are common in the respective embodiments.

FIG. 2 is a diagram illustrating an example of configurations in a prediction device according to a first embodiment.

FIG. 3 is a diagram illustrating an example of details of image data.

FIG. 4 is a diagram illustrating an example of details of released information.

FIG. 5 is a diagram for explaining processing performed by an image analyzer.

FIG. 6 is a diagram illustrating an example of details of an object state recognition model.

FIG. 7 is a diagram illustrating an example of details of a recognition model.

FIG. 8 is a diagram illustrating an example of details of an object state evaluation table.

FIG. 9 is a diagram illustrating a concept of a prediction model defined on a rule basis.

FIG. 10 is a flowchart illustrating an example of a flow of processing that is executed by the prediction device according to the first embodiment.

FIG. 11 is a diagram illustrating an example of a configuration of a prediction device according to a second embodiment.

FIG. 12 is a diagram schematically illustrating details of processing performed by a penalty learner.

FIG. 13 is a diagram illustrating an example of configurations in a prediction device according to a third embodiment.

FIG. 14 is a diagram schematically illustrating details of processing performed by a prediction model learner.

FIG. 15 is a diagram illustrating an example of configurations in a prediction device according to a fourth embodiment,

FIG. 16 is a diagram illustrating an example of details of a prediction model.

### DESCRIPTION OF EMBODIMENTS

Hereinafter, embodiments of a prediction device, a prediction method, and a storage medium according to the invention will be described with reference to drawings.

### <Common Configuration>

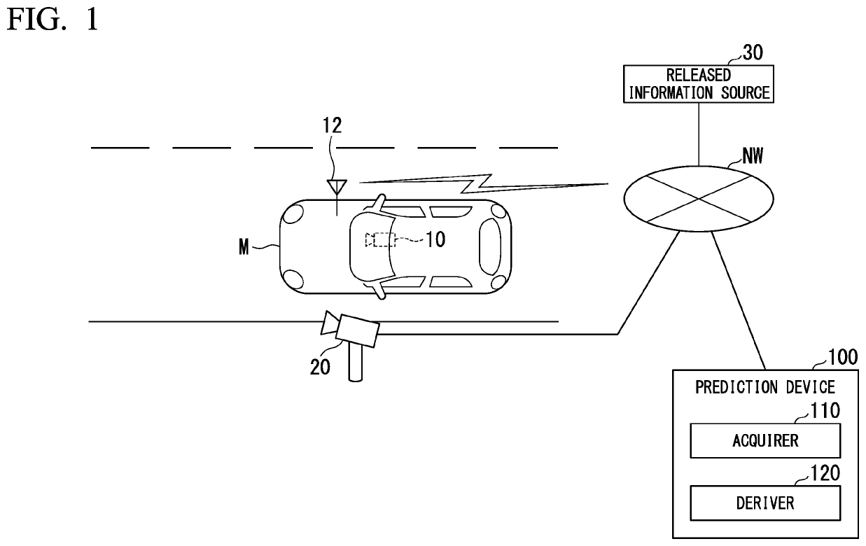

FIG. 1 is a diagram illustrating an example of configurations that are common in the respective embodiments. A prediction device 100 acquires an image of a town captured by an in-vehicle camera 10 mounted in a vehicle M via a wireless communication device 12 and a network NW. Alternatively, the prediction device 100 acquires an image of a town captured by a fixed camera 20 mounted in the town via the network NW. The network NW includes, for example, a cellular network, the Internet, a wide area network (WAN), a local area network (LAN), and the like. It is assumed that the configuration illustrated in the drawing includes an interface such as a network card for establishing connection to the network NW (the wireless communication device 12 is provided in the vehicle M). In a case in which an image is acquired from the in-vehicle camera 10, the prediction device 100 or another device performs control such that the in-vehicle camera 10 captures the image when a location as a target of prediction is reached (or an image at an arrival point is saved during successive image capturing). In this manner, one or more images of a desired location in a desired town captured from a desired direction by the in-vehicle camera 10 or the fixed camera 20 are provided to the prediction device 100. Hereinafter, such images will be referred to as image data.

The prediction device 100 acquires released information from a released information source 30. The released information is arbitrary released information that is considered to represent a value of the town such as a roadside land assessment, a rent per reference, area and a crime occurrence rate. In the following respective embodiments, it is assumed that the released information is a roadside land assessment. The released information source 30 is, for example, an information provision device that releases such information on a website or the like. The prediction device 100 automatically acquires the released information as electronic information from the website using a technology such as a crawler, for example. Instead of this, an operator who has viewed the released information may manually input the released information to an input device (not illustrated) of the prediction device 100.

The prediction device 100 derives a public safety index representing public safety in the town on the basis of the images captured by the in-vehicle camera 10 or the fixed camera 20 and the released information. Hereinafter, variations of a method of deriving the public safety index will be described in the respective embodiments.

### First Embodiment

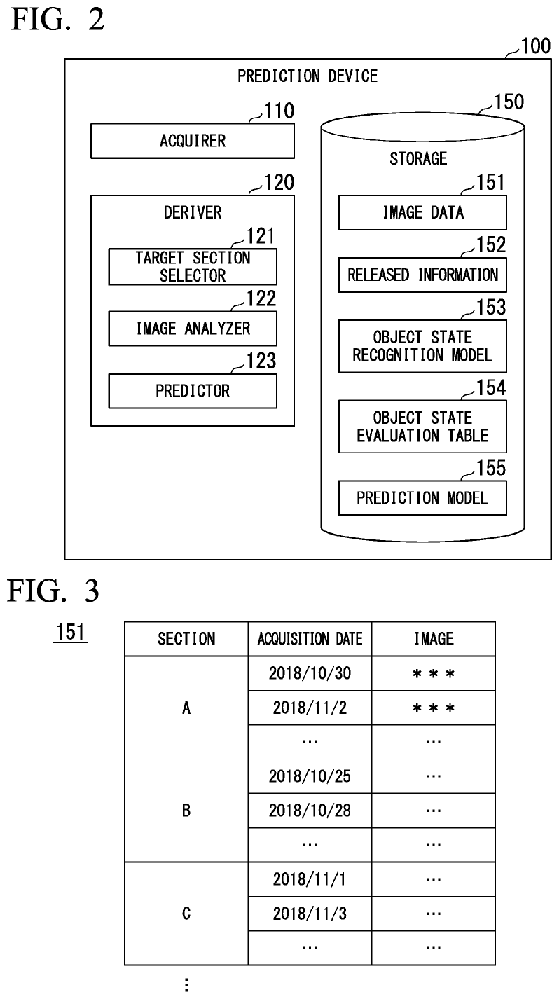

FIG. 2 is a diagram illustrating an example of a configuration in the prediction device 100 according to a first embodiment. The prediction device 100 includes, for example, an acquirer 110, a deriver 120, and a storage 150. The respective parts of the acquirer 110 and the deriver 120 are realized by a hardware processor such as a central processing unit (CPU) executing a program (software), for example. Some or all of these components may be realize by hardware (a circuit unit; including a circuitry) such as a large scale integration (LSI), an application specific integrated circuit (ASIC), a field-programmable gate array (FPGA), or a graphics processing unit (GPU) or may be realized through cooperation of software and hardware. The program may be stored in advance in a storage device (a storage device provided with a non-transitory storage medium) such as a hard disk drive (HDD) or a flash memory or may be stored in a detachable storage medium (non-transitory storage medium) such as a DVD or a CD-ROM and may be installed by the storage medium being attached to a drive device. The storage device that functions as a program memory may be the same as the storage 150 or may be different from the storage 150.

The acquirer 110 acquires the image data and the released information and causes the storage 150 to store them as image data 151 and released information 152. The storage 150 is realized by an HDD, a flash memory, or a RAM, for example. In the storage 150, the image data 151 is organized for each section in a chronological order, for example. The section is a specific section along a specific road, and more specifically, the section is a road corresponding to one block. FIG. 3 is a diagram illustrating an example of details of the image data 151. As illustrated in the drawing, the image data 151 is information in which image acquisition dates and images are associated with section identification information.

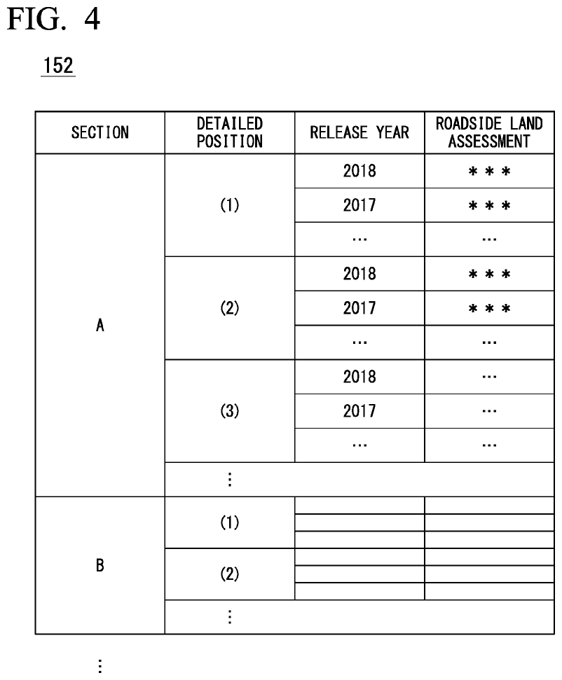

The released information 152 is organized as chronological information for each release period (for example, each release year) that is periodically reached with a finer granularity than the aforementioned sections, for example. FIG. 4 is a diagram illustrating an example of details of the released information 152. As illustrated in the drawing, the released information 152 is information in which detailed positions, release years, and roadside land assessments are associated with a section. The detailed positions are positions divided according to units of frontages of buildings, for example.

The deriver 120 includes, for example, a target section selector 121, an image analyzer 122, and a predictor 123.

The target section selector 121 selects a target section as a target of prediction from sections. For example, the target section selector 121 may select, as a target section, a section with a rate of change in the released information 152 between a first timing and a second timing that is a reference value among the sections. As described above, in a case in which a granularity of the released information 152 is finer than that of the section, the target section selector 121 obtains one scalar value by obtaining an average value of the released information 152 in the section and defines it as a determination target. The first timing is the release timing previous to the most recent timing (2017 in the example in FIG. 4), and the second timing is the most recent release timing (2018 in the example in FIG. 4) among periodic release timings of the released information 152.

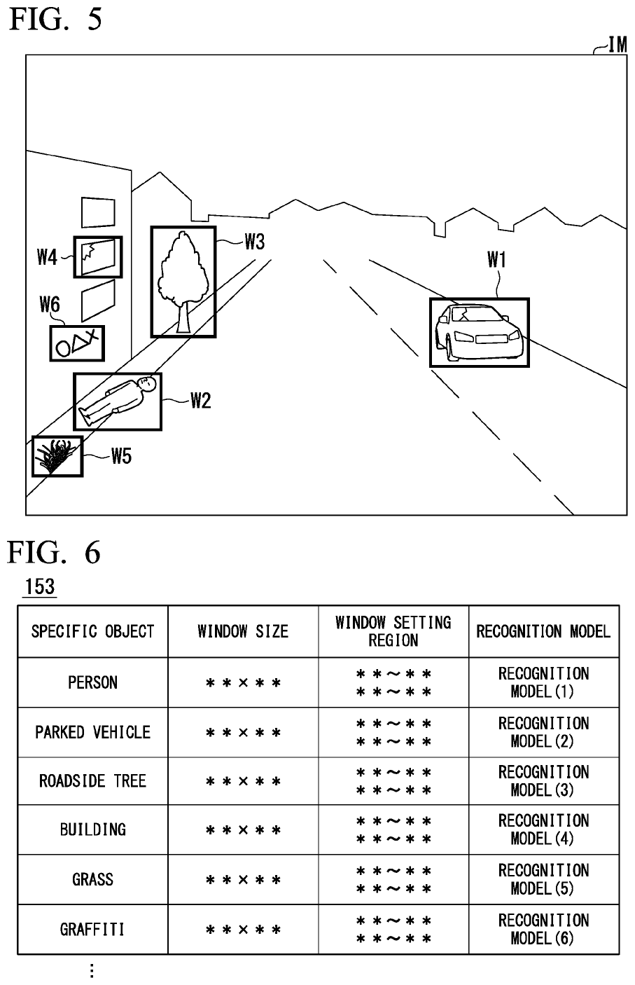

The image analyzer 122 analyzes an image corresponding to the target section selected by the target section selector 121, thus evaluating a state of a specific object included in the image, and outputs evaluation points. FIG. 5 is a diagram for explaining processing performed by the image analyzer 122. The image analyzer 122 sets windows W (in the drawing, W1 to W6 are illustrated) with various sizes in an image IM as a target of analysis, at least a part of the image IM is scanned, and in a case in which inclusion of a specific object in the windows W is detected, the image analyzer 122 recognizes a state thereof. The specific object is, for example, a person, a parked vehicle, a roadside tree, a building, a plant (grass) other than a roadside tree, graffiti on a building wall, or the like. In the drawing, a vehicle with a broken front windshield is included in the window W1, a person who is lying down on a pedestrian road is included in the window W2, an untrimmed roadside tree is included in the window W3, a broken building window is included in the window W4, grass is included in the window W5, and graffiti is included in the window W6. The image analyzer 122 recognizes a state of each specific object as described above.

The image analyzer 122 uses an object state recognition model 153 to perform the processing of recognizing a state of an object. FIG. 6 is a diagram illustrating an example of details of the object state recognition model 153. As illustrated in the drawing, the object state recognition model 153 is information in which window sizes, window setting regions, recognition models, and the like are associated with types of specific objects. The window sizes are the sizes of the windows W set in accordance with types of specific object. The window sizes may be corrected to be larger toward the lower end of the image IM and smaller toward the upper end in consideration of a perspective method. The window setting regions are regions in which the windows are set to be scanned in the image IM in accordance with the types of specific object. For example, window setting regions are set around both ends of the image in the width direction for buildings since there is a low probability that a building will appear around the center of the image.

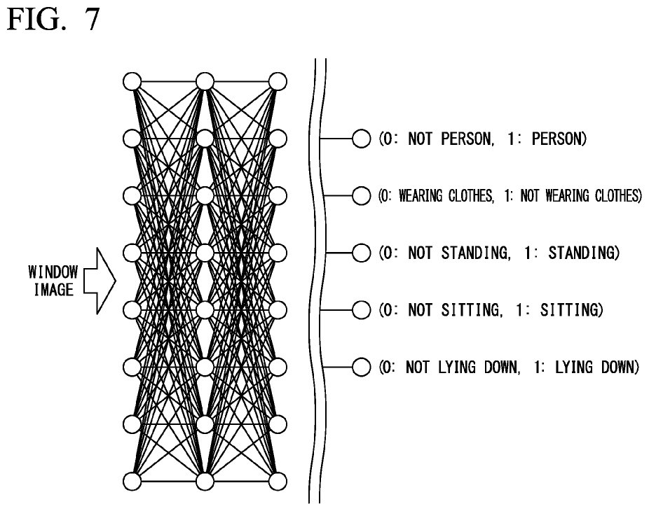

FIG. 7 is a diagram illustrating an example of details of a recognition model. The recognition model is, for example, a model for which learning has been completed through deep learning using a convolution neural network (CNN) or the like. The recognition model illustrated in the drawing is a recognition model (1) regarding persons, and if images in the windows W (window images) are input, the recognition model outputs, in an output layer, information regarding whether or not the images include a person, and in a case in which any person is included, whether or not the person is wearing clothes, whether or not the person is standing, sitting, or lying down, and the like.

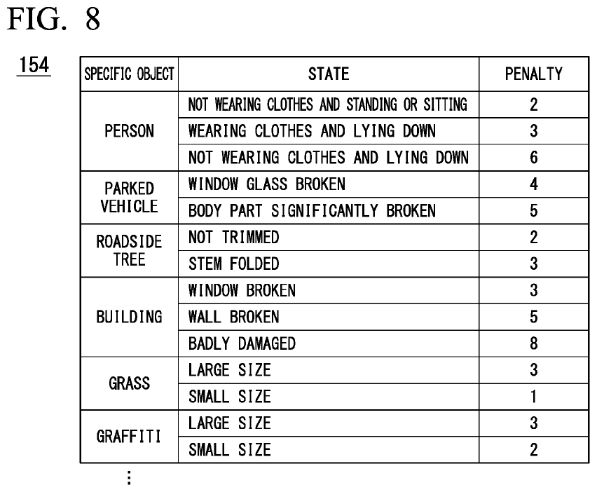

Further, the image analyzer 122 evaluates a state of a recognized specific object using an object state evaluation table 154 and outputs evaluation points. FIG. 8 is a diagram illustrating an example of details of the object state evaluation table 154. As illustrated in the drawing, the object state evaluation table 154 is information in which penalties are associated with the respective states of the specific object. The object state evaluation table 154 is generated in advance by some method (through human decision, for example) and is stored in the storage 150. The image analyzer 122 sums penalties corresponding to the evaluated state and calculates a total penalty (an example of the evaluation points) for the image IM.

The predictor 123 derives a public safety index representing a public safety state of the target section in the future on the basis of the total penalty calculated by the image analyzer 122 and the released information 152 of the target section. On the assumption that it is 2018 now, for example, the predictor 123 derives a public safety index in the future (2019, for example) on the basis of Equation (1) defined in advance as a prediction model 155. In the equation, [total penalty (2018)] is a total penalty based on images acquired in 2018. Hereinafter, this will be expressed as “a total penalty in 2018” in some cases.

[Public safety index(2019)]=F{[total penalty(2018)],[released information (2018)],[released information(2017)], . . . [released information(n years ago)] (1)

Although Equation (1) described above are expressed such that only images related to one acquisition data are used as input data in regard to the images, images in a chronological order may be used as input data in regard to images similarly to the released information 152. In this case, the predictor 123 may derive the public safety index on the basis of total penalties based on images over a plurality of years, such as a total penalty based on images acquired in 2018, a total penalty based on images acquired in 2017, and a total penalty based on images acquired in 2016.

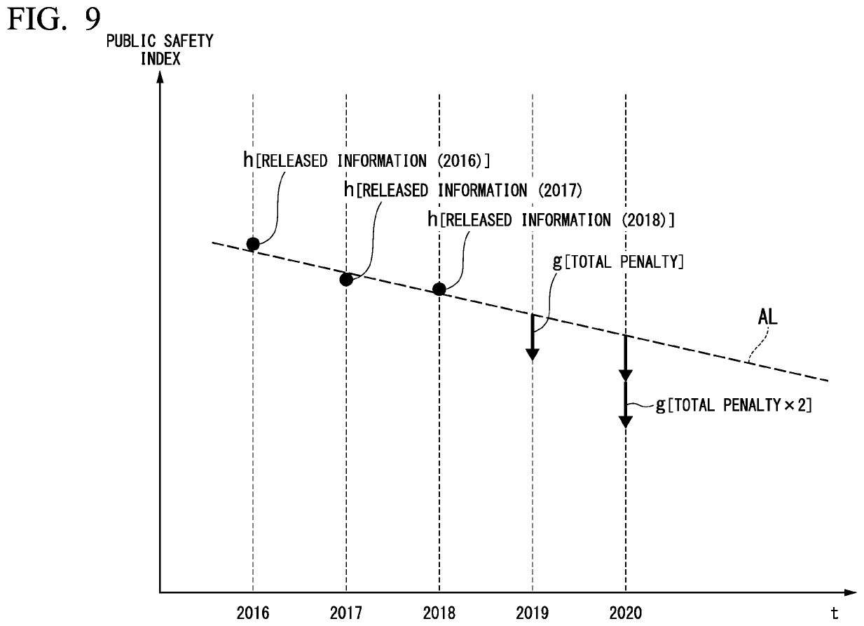

The prediction model 155 represented by F in Equation (1) is a function determined on a rule basis, for example. Instead of this, the prediction model 155 may be a function representing a model that has finished learning through machine learning. FIG. 9 is a diagram illustrating a concept of the prediction model 155 defined on a rule basis. Here, it is assumed that a smaller public safety index represents “poorer public safety”. In the drawing, h is a function of released information in each year, and the function outputs a larger positive value as the released information represents “better public safety” (a higher roadside land assessment, a higher rent, or a lower crime occurrence rate). g is a function of a total penalty, and the function outputs a positive correlation value with respect to the total penalty. AL is an approximate line of approximating transition of an h value. The prediction model 155 outputs a value obtained by subtracting a value of the function g from a value at an intersection between the approximate line AL and the prediction target year. At this time, the input value of the function g may be a cumulatively added value such as a total penalty for a one-year later prediction target and a total penalty×2 for a two-year later prediction target. This principle does not reflect an inference that “the total penalty should be large for a target section with an originally low roadside land assessment”, the function g may output a value indicating a positive correlation to “a total penalty that has been corrected so as to be smaller as the value at the intersection of the approximate line AL at the prediction target is smaller”.

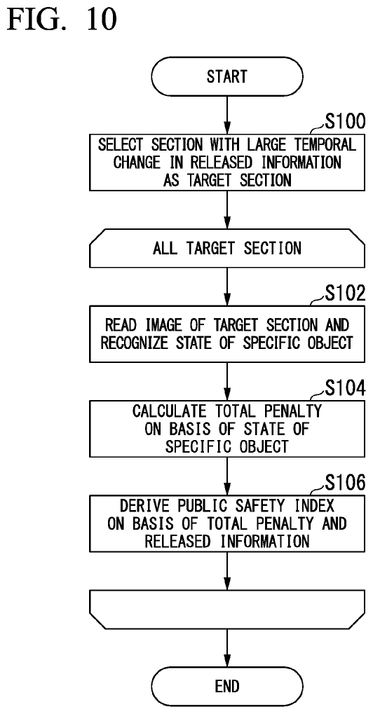

FIG. 10 is a flowchart illustrating an example of a flow of processing executed by the prediction device 100 according to the first embodiment. It is assumed that acquisition of data such as image data 151 and released information 152 are executed independently from the processing in this flowchart.

First, the target section selector 121 selects sections with large temporal changes in released information 152 as target sections (Step S100).

Next, the prediction device 100 performs processing in Steps S102 to S106 on all the target sections selected in Step S100. First, the image analyzer 122 reads images in a focused target section, recognizes information of specific objects (Step S104), and calculates a total penalty on the basis of states of the recognized specific objects (Step S106). Then, the predictor 123 derives a public safety index on the basis of the total penalty and the released information 152 for the target section (Step S106).

According to the prediction device 100 in the aforementioned first embodiment, it is possible to appropriately estimate a public safety state in the future.

### Second Embodiment

Hereinafter, a second embodiment will be described. Although the object state evaluation table 154 that defines a penalty for each state of a specific object is preset by some method in the first embodiment, the object state evaluation table 154 is generated through machine learning in the second embodiment.

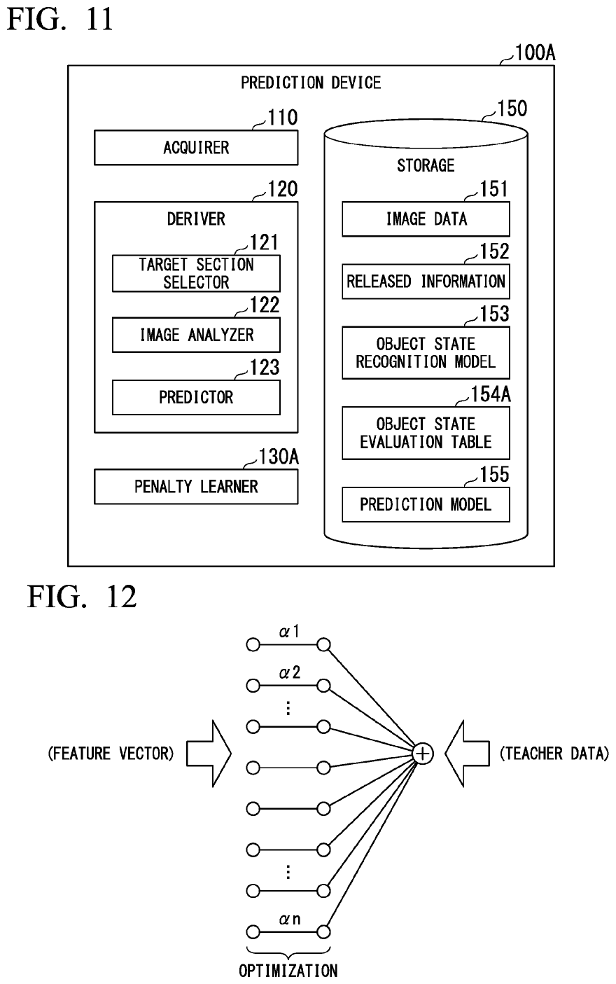

FIG. 11 is a diagram illustrating an example of configurations in a prediction device 100A according to a second embodiment. The prediction device 100A further includes a penalty learner 130A in comparison with the prediction device 100 according to the first embodiment. An object state evaluation table 154A is generated by a penalty learner 130A.

The penalty learner 130A selects one image (it is desirable that the acquisition date is sufficiently older than now) from among a plurality of images in order and generates a feature vector by assigning 1 to a case that corresponds to each state of a specific object and assigning 0 to a case that does not correspond thereto for the selected image. The feature vector is represented by Equation (2). In the equation, fk is a kth “state of a specific object” and is a binary value of 0 or 1. n is the number (type) of “the states of the specific objects” assumed.

(Feature vector)=(f1,f2, . . . ,fn) (2)

Then, the penalty learner 130A learns coefficients α1 to αn such that a correlation between values obtained by multiplying the respective elements of the feature vector by the respective coefficients α1 to αn as penalty and teacher data is maximized in regard to a plurality of target sections (or images). The teacher data represents a public safety state of the target section regarding the selected image in the future, for example, and released information 152 may be used as teacher data, or other information may be used as teacher data. Such processing can be represented by a numerical equation as Equation (3). In the equation, argmax is a function for obtaining a parameter representing a maximum value, and Correl is a correlation function. The teacher data is information of a year of a desired number of years after the acquisition data of the image. In a case in which the acquisition date of the image is 2015, for example, teacher data in 2017 and 2018 are input as parameters of Equation (3). FIG. 12 is a diagram schematically illustrating details of processing performed by the penalty learner 130A. The penalty learner 130A obtains the coefficients al to an through back-propagation, for example.

α1 to αn=arg max_{α1 to αn}[Correl{Σₖ₋₁ⁿ(fk×αk)},(teacher data)] (3)

Processing after the object state evaluation table 154A is generated is similar to that in the first embodiment, and description will be omitted.

According to the prediction device 100A in the aforementioned second embodiment, it is possible to appropriately estimate a public safety state in the future. It is possible to perform estimation with higher accuracy by generating the object state evaluation table 154A through machine learning as compared with a case in which the object state evaluation table 154A is determined on a rule basis.

### Third Embodiment

Hereinafter, a third embodiment will be described. Although the released information 152 is used as input data for deriving a public safety index in the first and second embodiments, the released information 152 is used mainly as teacher data for machine learning in the third embodiment.

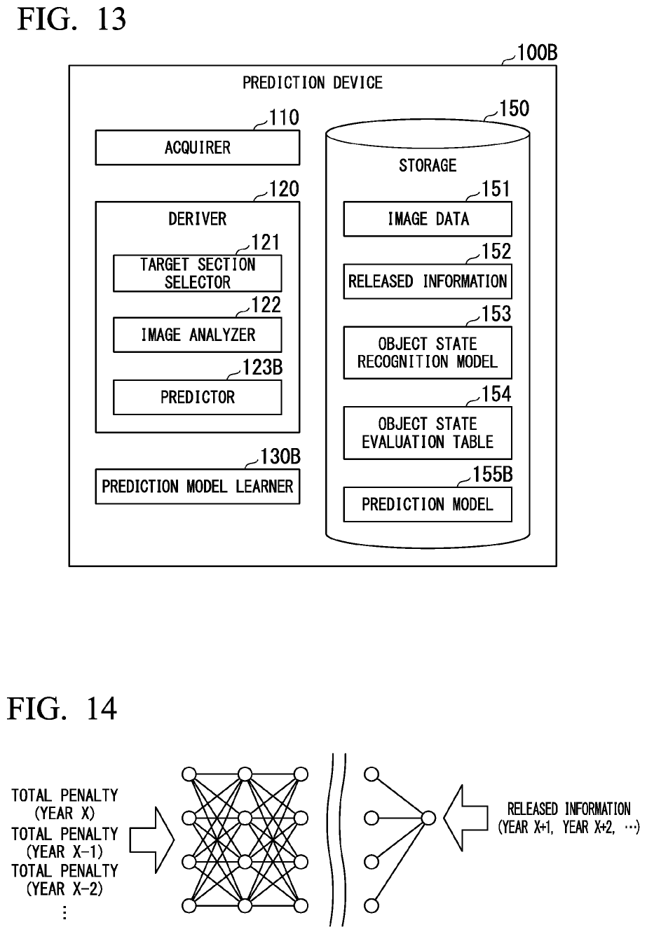

FIG. 13 is a diagram illustrating an example of configurations in a prediction device 100B according to a third embodiment. The prediction device 100B further includes a prediction model learner 130B in comparison with the prediction device 100 according to the first embodiment. A prediction model 155B may be generated by the prediction model learner 130B.

A predictor 123B according to the third embodiment derives a public safety index representing a public safety state of a target section in the future on the basis of a total penalty calculated by the image analyzer 122. On the assumption that it is 2018 now, for example, the predictor 123B derives a public safety index in the future (2019, for example) on the basis of Equation (4) defined in advance as a prediction model 155

[Public safety index(2019)]=Q{[total penalty(2018)],[total penalty(based on images acquired in 2017)],[total penalty(based on images acquired in 2016)]} (4)

The prediction model 155B represented by Q in Equation (4) is a function representing a model that has finished learning through machine learning performed by the prediction model learner 130B using the released information 152 as teacher data. FIG. 14 is a diagram schematically illustrating details of processing performed by the prediction model learner 130B. As illustrated in the drawing, the prediction model learner 130B performs machine learning using total penalties in a year X, a year X−1, and a year X−2, for example, as input data and using released information 152 in a year X+1, a year X+2, . . . as teacher data and generates a model that has finished learning.

In the third embodiment, the object state evaluation table 154A may be generated through machine learning in the third embodiment as well similarly to the second embodiment. Since other processing is similar to that in the first embodiment, description will be omitted.

According to the prediction device 100B in the aforementioned third embodiment, it is possible to appropriately estimate a public safety state in the future. It is possible to perform estimation with higher accuracy by generating the prediction model 155B through machine learning as compared with a case in which the prediction model 155B is determined on a rule basis.

### Fourth Embodiment

Hereinafter, a fourth embodiment will be described. Although the image analyzer 122 calculates the total penalty in the first to third embodiments, this is omitted in the fourth embodiment, and mages are input directly to the prediction model.

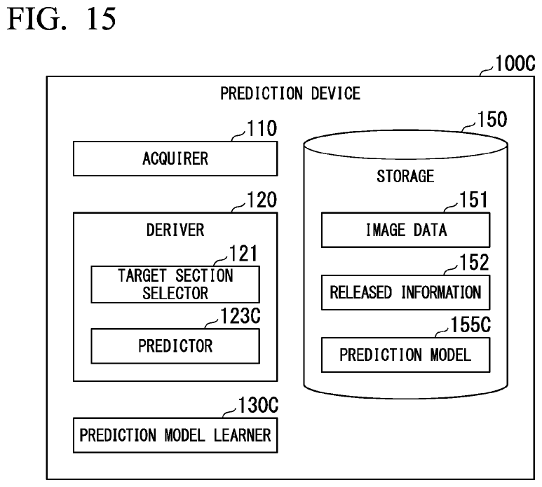

FIG. 15 is a diagram illustrating an example of configurations in a prediction device 100C according to the fourth embodiment. The prediction device 100C further includes a prediction model learner 130C, and the image analyzer 122 is omitted therefrom, in comparison with the prediction device 100 according to the first embodiment. A prediction model 155C is generated by the prediction model learner 130C.

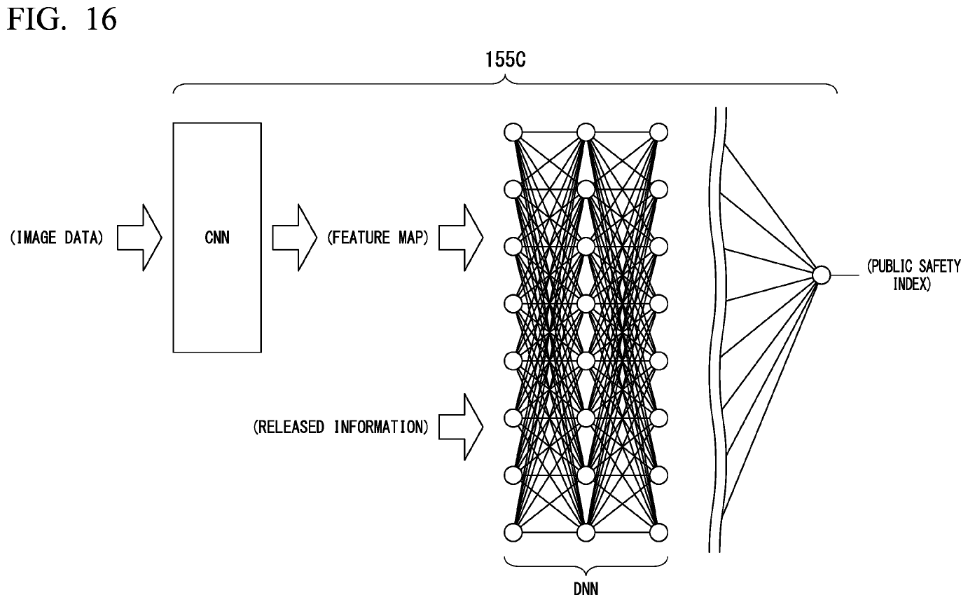

A predictor 123C according to the fourth embodiment inputs image data 151 of a target section and released information 152 to the prediction model 155C and derives a public safety index. FIG. 16 is a diagram illustrating an example of details of the prediction model 155C. As illustrated in the drawing, the prediction model 155C is a model that obtains a feature map by inputting the image data 151 to a CNN, inputs the feature map and the released information 152 to a network such as a deep neural network (DNN), and thus derives a public safety index.

The prediction model learner 130C determines parameters of the CNN and the DNN illustrated in FIG. 16 by performing back-propagation from teacher data, for example. The released information 152 may be used as teacher data, or other information may be used as teacher data.

In the fourth embodiment, the released information 152 may be used only as teacher data for generating the prediction model 155C mainly through machine learning without being used as data input to the prediction model 155C.

According to the prediction device 100C in the aforementioned fourth embodiment, it is possible to appropriately estimate a public safety state in the future. Since image analysis processing is omitted, there is a probability that higher-speed processing can be realized.

Although the embodiments regarding modes for carrying out the invention have been described above, the invention is not limited to such embodiments, and various modifications and replacements can be made without departing from the gist of the invention.

What is claimed is:

1. A prediction device comprising:
an acquirer configured to acquire a captured image of a scene of a section in a town and a released information representing a value for the section; and
a deriver configured to derive a public safety index representing a public safety state of the section in the future by inputting a result of analyzing the image and the released information to a prediction model.

2. The prediction device according to claim 1,
wherein the deriver derives the public safety index for a section with a rate of change in the released information that is equal to or greater than a reference value.

3. The prediction device according to claim 1,
wherein the deriver derives the public safety index by evaluating a state of a specific object included in the image.

4. The prediction device according to claim 1,
wherein the released information includes at least a part of information related to roadside land assessments, rents, and crime occurrence.

5. The prediction device according to claim 1,
wherein the section is a specific section along a road.

6. The prediction device according to claim 1, further comprising:
a learner that generates the prediction model through machine learning.

7. The prediction device according to claim 1,
wherein the released information is used as teacher data when the prediction model for deriving the public safety index is learned.

8. A prediction method that is performed using a computer, the method comprising:
acquiring a captured image of a scene of a section in a town and released information representing a value for the section; and
deriving a public safety index representing a public safety state of the section in the future by inputting a result of analyzing the image and the released information to a prediction model.

9. A computer-readable non-transitory storage medium that stores a program for causing a computer to:
acquire a captured image of a scene of a section in a town and released information representing a value for the section; and
derive a public safety index representing a public safety state of the section in the future by inputting a result of analyzing the image and the released information to a prediction model.
